(19) United States
(12) Patent Application Publication
(10) Pub. No.: US 2005/0183855 A1
(43) Pub. Date: Aug. 25, 2005

(54) Air conditioning apparatus for vehicle and method for controlling the same

(75) Inventor: Tomoki Izawa, Aichi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 11/024,876

(22) Filed: Dec. 30, 2004

(30) Foreign Application Priority Data
Feb. 23, 2004 (JP) 2004-046888

(51) Int. Cl. B60H 1/00

(52) U.S. Cl. 165/203

(57) ABSTRACT

A plurality of ducts is connected to a plurality of blow-off ports provided in a compartment of a vehicle. An air flow passage includes an external opening that is opened to outside of the vehicle. A duct opening/closing unit opens/closes the air flow passage and the ducts. A heater is provided between the external opening and a portion of the air flow passage connected with the ducts. A cold-air bypass duct includes one end opened to the ducts and other end opened between the vehicle external opening and the heater through a cold-air bypass opening. A cold-air bypass opening/closing unit provided at either of the cold-air bypass opening and the cold-air bypass duct opens/closes the either of the cold-air bypass opening and the cold-air bypass duct independently of opening/closing the duct opening/closing unit.

### BACKGROUND OF THE INVENTION

1) Field of the Invention

The present invention relates to an air conditioning apparatus that can relieve a vehicle occupant from an uncomfortable feeling with a simple configuration or method, and a method for controlling the air conditioning apparatus.

2) Description of the Related Art

In a conventional air conditioning apparatus for a vehicle, temperatures of the air blown from blow-off ports provided in a vehicle compartment can be changed for each blow-off port so that temperature setting for a compartment temperature in the air conditioning apparatus for a vehicle can be adjusted for each seating position of passengers such that the passengers in the vehicle compartment can feel comfortable. Therefore, even if only a driver feels hot due to exposure of a driver's side to the direct sunlight and a front passenger feels comfortable or a proper temperature, for example, during heating, only a compartment temperature near a driver seat can be lowered, while maintaining a compartment temperature near a front passenger seat, by lowering a temperature setting on a driver seat side. Thereby, both occupants sitting on the driver seat and on the front passenger seat will feel comfortable. Thus, even if spaces in the driver seat side and the front passenger seat side are different in such an environment as an amount of solar radiation, both spaces can be set to proper compartment temperatures so that the passengers will not feel uncomfortable.

In such an air conditioning apparatus for a vehicle, however, since the spaces on the driver seat side and the front passenger seat side are temperature-adjusted separately, when only a driver rides on a vehicle, such a case arises that a temperature on only the driver seat side is set in view of reduction in load on the air conditioning apparatus for a vehicle. In this case, though air with a temperature suitable for adjusting the driver seat side to a temperature set by the driver is blown out from the blow-off port near the driver seat to the vehicle compartment, such air is not blown from the blow-off port near the front passenger seat because the front passenger seat side is not temperature-set. For this reason, a temperature on the front passenger seat side is hardly changed by the air conditioning apparatus for a vehicle. Though an air intake port of the air conditioning apparatus for a vehicle to be disposed on the vehicle compartment side is usually provided near the front passenger seat, since the compartment temperature near the front passenger seat is hardly changed, air with a temperature different from that set for the driver seat side is always taken in the air conditioning apparatus for a vehicle. Accordingly, setting a compartment temperature only on the driver seat side may result in increase in load on the air conditioning apparatus for a vehicle.

In order to solve such a problem, Japanese Patent Application Laid-open Publication No. H6-32139 discloses a technique that the air intake port is provided around the blow-off port provided near feet of an occupant on the front passenger seat, and when the air conditioning apparatus for a vehicle is actuated in a'seating state of an occupant on only the driver seat, temperature-adjusted air is blown from the blow-off port provided near feet of an occupant on the front passenger seat. Since the air intake port is provided near the blow-off port, air blown from the blow-off port is immediately taken in the air intake port. Therefore, temperature-adjusted air is taken in the air conditioning apparatus for a vehicle, so that load on the air conditioning apparatus for a vehicle can be securely reduced when partial temperature adjustment, namely, temperature adjustment for only the driver seat side is conducted.

In the air conditioning apparatus for a vehicle described above, however, since consideration has been made about reduction in load on the air conditioning apparatus for a vehicle imparted when there is a passenger on only the driver seat, actuation is made in the same manner as the conventional air conditioning apparatus for a vehicle when there is a passenger on a seat other than the driver seat. Therefore, when plural passengers feel comfortable at different temperatures due to a difference in an amount of solar radiation from the outside of the vehicle or the like, the air conditioning apparatus for a vehicle is operated such that temperatures of airs blown from blow-off ports corresponding to respective passenger seats are made different by set temperatures to the respective passenger seats independently. The conventional air conditioning apparatus for a vehicle employs such a configuration that a set temperature can be changed for each seat position, a configuration thereof becomes complicated. Further, for example, there occurs a case that a passenger desires changing temperatures of only airs blown from some of the blow-off ports, such a case that, because only the upper half of the body of a passenger is exposed to direct solar radiation during heating, the passenger desires cooling of only his/her upper half of the body. In such a case, in the conventional air conditioning apparatus for a vehicle, since it is necessary to perform temperature setting for each blow-off port, the configuration therein becomes further complicated. Thus, an air conditioning apparatus for a vehicle that allows detailed temperature setting for each blow-off port and has a complicated configuration with a complicated method of control.

### SUMMARY OF THE INVENTION

It is an object of the present invention to solve at least the above problems in the conventional technology.

An air conditioning apparatus for a vehicle according to one aspect of the present invention includes a plurality of ducts that is connected to a plurality of blow-off ports provided in a compartment of the vehicle; an air flow passage to which the ducts are connected, the air flow passage having a vehicle external opening that is a portion opened to outside of the vehicle; a duct opening/closing unit that opens/closes the air flow passage and the ducts; a heater provided between the vehicle external opening and a portion of the air flow passage connected with the ducts; a cold-air bypass duct with one end opened to the ducts and other end opened between the vehicle external opening and the heater through a cold-air bypass opening; and a cold-air bypass opening/closing unit that is provided at either of the cold-air bypass opening and the cold-air bypass duct, and opens/closes the either of the cold-air bypass opening and the cold-air bypass duct independently of opening/closing the duct opening/closing unit.

A method according to another aspect of the present invention, which is for controlling an air conditioning apparatus having a duct that feeds air into a compartment of a vehicle and a cold-air bypass duct opened to the duct to feed cold air into the compartment in response to feeding the air from the duct, includes detecting an amount of solar radiation irradiated on the vehicle; and adjusting an amount of the cold air from the cold-air bypass duct based on the amount of the solar radiation in such a manner that the amount of the cold air increases as the amount of solar radiation detected increases, and the amount of the cold air decreases as the amount of solar radiation detected decreases.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram of an air conditioning apparatus for a vehicle according to a first embodiment of the present invention;

FIG. 2 is a side view of a vehicle equipped with the air conditioning apparatus for a vehicle shown in FIG. 1;

FIG. 3 is a block diagram of a configuration of parts or members connected to a control unit;

FIG. 4 is a graph of an opening degree of a cold-air bypass damper corresponding to a solar radiation amount;

FIG. 5 is a diagram of opening and closing of a cold-air bypass damper corresponding to an outside temperature;

FIG. 6 is a diagram of opening and closing of the cold-air bypass damper corresponding to a vehicle compartment temperature;

FIG. 7 is a view of an air conditioning apparatus for a vehicle according to a second embodiment of the present invention;

FIG. 8 is a view of the air conditioning apparatus for a vehicle seen from arrow A-A in FIG. 7;

FIG. 9 is a sectional view of the air conditioning apparatus for a vehicle taken along line B-B in FIG. 7;

FIG. 10 is a plan view of a vehicle equipped with the air conditioning apparatus for a vehicle shown in FIG. 7;

FIG. 11 is a view of an operation panel of the air conditioning apparatus for a vehicle according to the second embodiment;

FIG. 12 is a diagram of opening and closing of a cold-air bypass damper corresponding to polarized solar radiation amount;

FIG. 13 is a diagram of opening and closing of a cold-air bypass damper corresponding to a difference in set temperatures;

FIG. 14 is a diagram of opening and closing of a hot-air bypass damper to a difference between set temperatures;

FIG. 15 is a modification of the first embodiment;

FIG. 16 is an example of an operation panel of an air conditioning apparatus for a vehicle according to the present invention; and

FIG. 17 is another example of an operation panel of an air conditioning apparatus for a vehicle according to the present inventions

### DETAILED DESCRIPTION

Exemplary embodiments of an air conditioning apparatus for a vehicle and a method for controlling the air conditioning apparatus according to the present invention will be explained below in detail with reference to the accompanying drawings. Note that the present invention is not limited by the embodiments. Constituent elements in the embodiments include ones easily replaceable by the persons skilled in the art or one that are substantially the same.

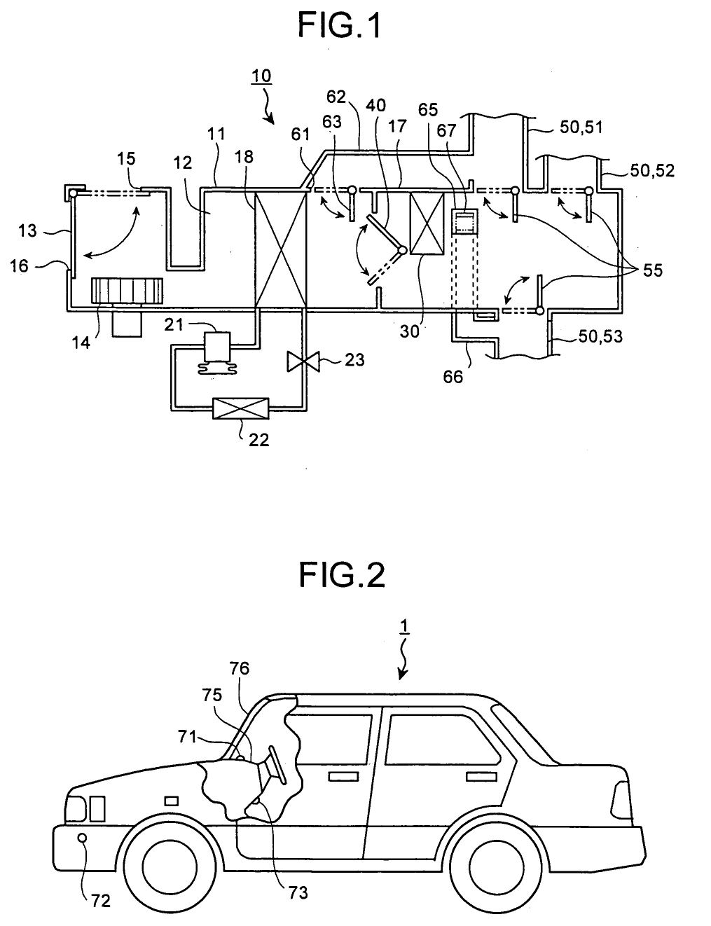

FIG. 1 is a diagram of an air conditioning apparatus for a vehicle according to a first embodiment of the present invention. An air conditioning duct 11 having an air flow passage 12 therein is provided at an upstream side of air flowing in the air flow passage 12 with a vehicle external opening 15 and a vehicle internal opening 16. The vehicle external opening 15 is formed such that the air flow passage 12 is opened outside a vehicle 1 provided with the air conditioning duct 11. The vehicle internal opening 16 is provided such that the air flow passage 12 is opened to the outside of the vehicle 1. An inside air/outside air switching damper 13 is provided around the vehicle external opening 15 and the vehicle internal opening 16, and the damper 13 performs switching so as to open one of the vehicle external opening 15 and the vehicle internal opening 16. An air blower 14 is provided downstream of the vehicle external opening 15 and the vehicle internal opening 16.

An evaporator 18 is provided downstream of the air blower 14 in the airflow passage 12. The evaporator 18 conducts heat exchange between the evaporator 18 and air passing therethrough to remove moisture from the air and cool the air. The evaporator 18 configures a refrigerating cycle together with a compressor 21, a condenser 22, and an expansion valve 23. A heater 30 is provided downstream of the evaporator 18. The heater 30 performs heat exchange between the heater 30 utilizing cooling water heated by heat of an engine (not shown) as a heat source and air passing through the heater 30 to heat the air.

An air mixing damper 40 is provided between the evaporator 18 and the heater 30. The air mixing damper 40 serves to change a ratio of air flowing toward the heater 30 when air that has passed through the evaporator 18 further flows downstream.

A plurality of ducts 50 are connected to the air conditioning duct 11 downstream of the heater 30. These ducts 50 are connected to blow-off ports (not shown) provided inside the vehicle 1, so that air from the air conditioning duct 11 is blown from the blow-off ducts in predetermined directions. These ducts 50 are connected to a face duct 51 for blowing air around the face of a passenger in the vehicle 1, a foot duct 52 for blowing air around the feet of the passenger, and a defroster duct 53 for blowing air toward a front glass of the vehicle 1. A connecting portion of each of the ducts 50 and the air conditioning duct 11 is provided with a duct damper 55 serving as a duct opening/closing unit, respectively. An amount of air to be sent from the air flow passage 12 to each duct 50 can be changed by each duct damper 55.

A cooling-air bypass opening 61 opened toward outside of the air flow passage 12 is provided between the evaporator 18 and the heater 30, more specifically, between the evaporator 18 and a portion where the air mixing damper 40 is provided, and a cold-air bypass duct 62 is provided so as to extend from the cooling-air bypass opening 61 toward outside of the air conditioning duct 11. The cold-air bypass duct 62 is connected at one end thereof to the air flow passage 12 to be opened to the air flow passage 12 through the cooling-air bypass opening 61, as described above, while being connected at the other end to the face duct 51 to be opened to the inside of the face duct 51. Further, the cold-air bypass duct 62 is formed integrally with the air conditioning duct 11 along an outer wall 17 of the air conditioning duct 11 so as to extend from the cooling-air bypass opening 61 to the face duct 51 along the outer wall 17. A cooling-air bypass damper 63 serving as a cooling-air bypass opening/closing unit is provided at the cooling-air bypass opening 61. The cooling-air bypass damper 63 serves to open/close the cooling-air bypass opening 61 to change an amount of air flowing from the air flow passage 12 in the cold-air bypass duct 62. The cooling bypass damper 63 is opened/closed independently of opening/closing of the duct damper 55.

A hot-air bypass opening 65 opened toward the outside of the air flow passage 12 is provided between the heater 30 and a portion of the air conditioning duct 11 to which the duct 50 is connected, more specifically, near the downstream side of the heater 30, and a hot-air bypass duct 66 is provided so as to extend from the hot-air bypass opening 65 to the outside of the air conditioning duct 11. The hot-air bypass duct 66 is connected at one end thereof to the air flow passage 12 to be opened to the air flow passage 12 through the hot-air bypass opening 65, while being connected at the other end to the foot duct 52 to be opened to the inside of the foot duct 52. A hot-air bypass damper 67 serving as a hot-air bypass opening/closing unit is provided at the hot-air bypass opening 65. The hot-air bypass damper 67 serves to open/close the hot-air bypass opening 65 to change an amount of air flowing from the air flow passage 12 into the hot-air bypass duct 66. The hot-air bypass damper 67 is opened/closed independently of opening/closing the duct damper 55.

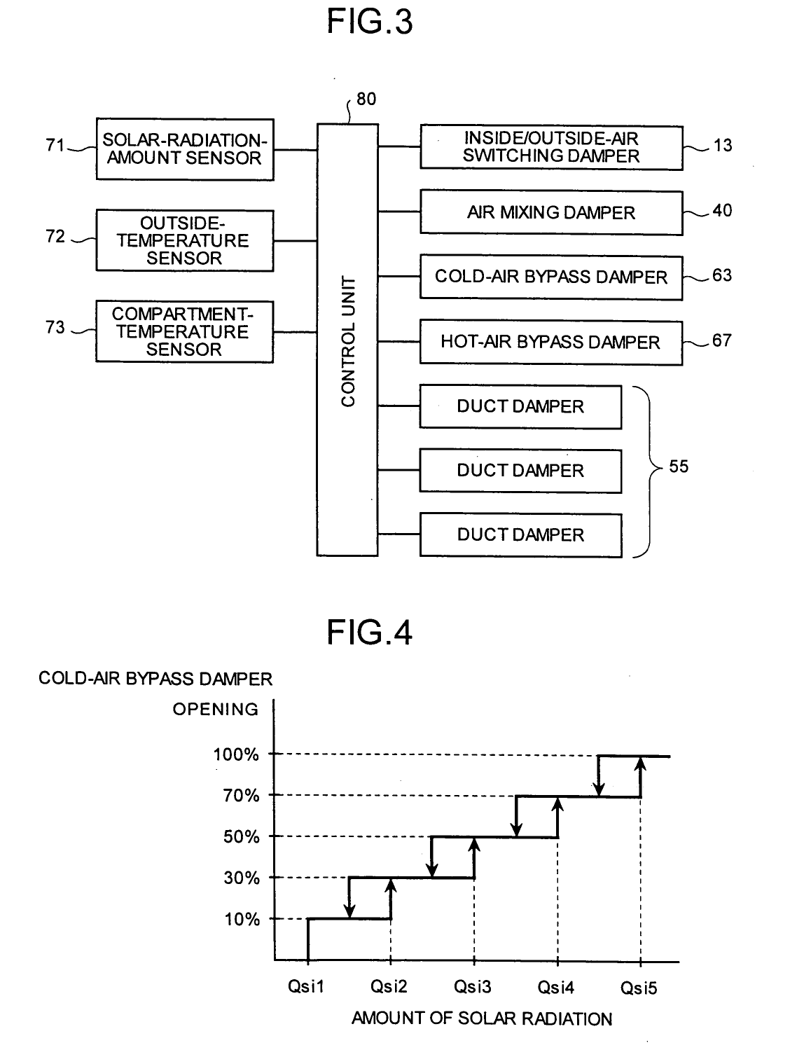

FIG. 2 is a side view of a vehicle equipped with the air conditioning apparatus for a vehicle shown in FIG. 1. FIG. 3 is a block diagram of a configuration of parts or members connected to a control unit. In the vehicle 1, a compartment (or room) sensor 73 is provided on a dashboard 75 in the vehicle compartment, and a solar radiation amount sensor 71 is provided on the dashboard 75 near a front glass 76. An outside air temperature sensor 72 is provided on an outside of the vehicle 1. The sensors are electrically connected to a control unit. 80 serving as control means. The control unit 80 is electrically connected with the inside air/outside air switching damper 13, the air mixing damper 40, the duct damper 55, the cooling-air bypass damper 63, and the hot-air bypass damper 67. The control unit 80 is configured of an electronic control unit (ECU) and-the like, and calculates an opening/closing amount of the cooling-air bypass damper 63 and the like based upon information or data from the solar radiation amount sensor 71 and the like to output the calculated opening/closing amount to the cooling-air bypass damper 63 and the like. Each damper such as the cooling-air bypass damper 63 is actuated by an actuator or the like.

The air conditioning apparatus for a vehicle according to the first embodiment is configured as described above, and an operation thereof will be explained below. When the air blower 14 inside the air flow passage 12 of the air conditioning duct 11 is actuated, air is introduced from the vehicle external opening 15 or the vehicle internal opening 16 into the air flow passage 12. The vehicle external opening 15 and the vehicle internal opening 16 are switched by the inside air/outside air switching damper 13 such that one thereof is opened for introducing air from the opened opening, as described above. Air introduced from the vehicle external opening 15 or the vehicle internal opening 16 into the air flow passage 12 is fed by the air blower 14 downstream, namely toward a connection portion of the air flow passage 12 to which the duct 50 is connected.

The air fed from the air blower 14 passes through the evaporator 18. The evaporator 18 is configured as a portion of the refrigerating cycle, as described above. Therefore, when the air passes through the evaporator 18, the air is subjected to moisture-removal and cooling during operation of the refrigerating cycle to flow downstream. On the contrary, while the refrigerating cycle is not being operated, the air flows downstream as it is without being subjected to heat exchange in the evaporator 18.

Since the air mixing damper 40 and the cooling-air bypass damper 63 provided downstream of the evaporator 18 are connected to the control unit 80, air flowing from the upstream side, namely, air flowing from the side of the evaporator 18 is controlled by the dampers 40 and 63. Since the cooling-air bypass damper 63 is provided at the cooling-air bypass opening 61, when the cooling-air bypass damper 63 is opened, air flowing from the upstream side thereof flows downstream, namely, toward the side of the air mixing damper 40 and simultaneously therewith flows into the cold-air bypass duct 62. When the cooling-air bypass damper 63 is closed, the air flows only downstream without flowing into the cold-air bypass duct.62. Since the cooling-air bypass damper 63 can be set to any state between a full opened state and a full closed state, an amount of air flowing in the cold-air bypass duct 62 can be controlled by controlling the degree of opening of the cooling-air bypass damper 63.

The heater 30 is provided downstream of the air mixing damper 40. The air mixing damper 40 functions to adjust a ratio of air flowing toward the heater 30 of the air flowing from the upstream side to the downstream side to air flowing downward without flowing toward the heater 30 thereof.

The hot-air bypass damper 67 provided near the heater 30 downstream thereof is provided at the hot-air bypass opening 65, air that has passed through the heater 30 flows downstream and simultaneously flows into the hot-air bypass duct 66 too, when the hot-air bypass damper 67 is opened. When the hot-air bypass damper 67 is closed, air that has passed through the heater 30 flows downstream as it is without flowing in the hot-air bypass duct 66. Since the hot-air bypass damper 67 is connected to the control unit 80, as described above, the hot-air bypass damper 67 can be set to any state between the opened state and the closed state, an amount of air flowing into the hot-air bypass duct 66 can be adjusted by controlling the degree of opening of the hot-air bypass damper 67.

Though the face duct 51, the foot duct 52, and the defroster duct 53 connected on the most downstream side of the air conditioning duct 11 are in communication with the air flow passage 12, an amount of air flowing in each duct 50 can be adjusted by the degree of opening/closing of each duct damper 55 provided at each connection portion between each duct 50 and the air conditioning duct 11. That is, since the duct damper 55 is connected to the control unit 80, an amount of air flowing from the air flow passage 12 into each duct 50 can be adjusted by controlling the degree of opening/closing of each duct damper 55.

Since each part or portion of the air conditioning apparatus for a vehicle is actuated as described above, for example, when the air conditioning apparatus for a vehicle 10 is used for heating, namely, when a passenger desires to raise a temperature in the compartment of the vehicle 1, air flowing from the upstream side toward the air mixing damper 40 is directed to the heat 30 by the air mixing damper 40, so that much of air flowing from the upstream side to the downstream side passes through the heater 30. The air heated by the heater 30 is fed to the vehicle compartment by opening each duct dampers 55 to feed the air into the each duct 50 so that the temperature in the vehicle compartment is raised. On the contrary, when the air conditioning apparatus for a vehicle 10 is used for cooling, namely, when a vehicle passenger desires to lower a compartment temperature in the vehicle compartment, air passing through the evaporator 18 is moisture-removed and cooled by actuating the refrigerating cycle, and air that has passed through the evaporator 18 is directed to flow downstream by the air mixing damper 40 without flowing toward the heater 30. The air cooled by the evaporator 18 is fed into the vehicle compartment by opening each duct damper 55 to feed the air into each duct 50 so that the temperature in the vehicle compartment is lowered.

Since the cold-air bypass opening 61 is provided upstream of the heater 30, air before passing through the heater 30 enters in the cold-air bypass duct 62. Therefore, air before being heated by the hater 30 enters in the cold-air bypass duct 62. Since the cold-air bypass duct 62 is connected to face duct 51 to be opened to the inside of the face duct 51, air entering in the inside of the cold-air bypass duct 62 is fed into the face duct 51. Air mixed with air fed from the cold-air bypass duct 62 is blown from the face duct 51 into the vehicle compartment. Since air from the cold-air bypass duct 62 is cooled, air with a low temperature is blown from the face duct 51 so that the temperature in the vehicle compartment is lowered.

Since the hot-air bypass opening 65 is provided just behind the heater 30, air that passes through the heater 30 before being mixed with air flowing downstream without passing through the heater 30 enters in the hot-air bypass duct 66. Therefore, the air that passes through the heater 30 before being mixed with air flowing downstream of the heater 30 without passing through the heater 30 to be lowered in temperature enters in the hot-air bypass duct 66. Since the hot-air bypass duct 66 is connected to the foot duct 52 to be opened to the inside of the foot duct 52, air entering in the inside of the hot-air bypass duct 66 is fed into the foot duct 52. Air mixed with air fed from the hot-air bypass duct 66 is blown from the foot duct 52 into the vehicle compartment. Since air from the hot-air bypass duct 66 is heated, air with a high temperature is blown from the foot duct 52 so that the temperature in the vehicle compartment is raised.

FIG. 4 is a graph of an opening degree of a cold-air bypass damper corresponding to a solar radiation amount. The solar radiation amount sensor 71, the outside temperature sensor 72, and the vehicle compartment sensor 73 connected to the control unit 80 detect environment values about the outside of the vehicle 1 and the vehicle compartment, and the cold-air bypass opening 61 is automatically controlled by the control unit 80 according to the environment values detected. For example, when the air conditioning apparatus for a vehicle 10 is used for heating, solar rays are externally incident on the solar radiation amount sensor 71 via the front glass 76, the cold-air bypass damper 63 is opened according to the amount of solar radiation. The cold-air bypass damper 63 is opened according to increase in amount of solar radiation in a stepwise manner via dead zones provided in the solar radiation amount sensor 71. Similarly, the cold-air bypass damper 63 is closed according to decrease in amount of solar radiation in a stepwise manner via the dead zones. For example, amounts of solar radiation are stepwise set to Qsi1, Qsi2, Qsi3, . . . , according to the amount of solar radiation detected by the solar radiation amount sensor 71. Such a configuration is employed that the cold-air bypass damper 63 is stepwise opened by a predetermined amount when the amount of solar radiation reaches a predetermined amount, for example, the cold-air bypass damper 63 that has been opened by 10% when the amount of solar radiation reaches Qsi1 is opened by 30% when the amount of solar radiation reaches Qsi2, and it is opened by 50% when the amount of solar radiation reaches Qsi3, or the like. Similarly, such a configuration is employed in closing the cold-air bypass damper 63 that the cold-air bypass damper 63 is stepwise closed by a predetermined amount when the amount of solar radiation reaches a predetermined amount. Thus, when the cold-air bypass damper 63 is opened, the outside air/inside air switching damper 13 is switched in a direction in which the vehicle external opening 15 is opened.

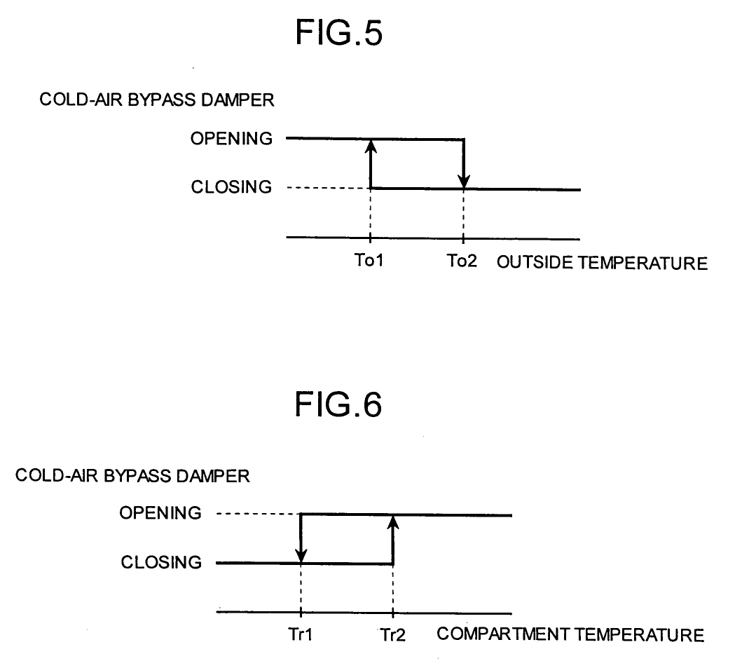

FIG. 5 is a diagram of opening and closing of a cold-air bypass damper corresponding to an outside temperature. FIG. 6 is a diagram of opening and closing of the cold-air bypass damper corresponding to a vehicle compartment temperature. Predetermined temperatures To1 and To2 (To1<To2) are set to the outside temperature in advance, and predetermined temperatures Tr1 and Tr2 (Tr1<Tr2) are similarly set to the compartment temperature in advance. When the outside temperature reaches To2 or more in an opened state of the cold-air bypass damper 63, the cold-air bypass damper 63 is closed. On the other hand, when the outside temperature reaches To1 or less in a closed state of the cold-air bypass damper 63, the cold-air bypass damper 63 is opened. As regards the compartment temperature, when the compartment temperature reaches Tr1 or less in an opened state of the cold-air bypass damper 63, the cold-air bypass damper 63 is closed. On the other hand, when the compartment temperature reaches Tr2 or more in a closed state of the cold-air bypass damper 63, the cold-air bypass damper 63 is opened. Under these conditions, the cold-air bypass damper 63 is fully opened only when the outside temperature reaches To1 or less and the compartment temperature reaches Tr2 or more. The cold-air bypass damper 63 is fully closed only when the outside temperature reaches To2 or more and the compartment temperature reaches Tr2 or less. When the outside temperature is high and when the compartment temperature is low, that is, when the outside temperature is To2 or more and when the compartment temperature is Tr1 or less, the cold-air bypass damper 63 is also closed fully. In the other cases, the cold-air bypass damper 63 is actuated so as to meet the actuation condition of the cold-air bypass damper 63 to the compartment temperature.

In the air conditioning apparatus for a vehicle 10 as described above, by providing the cold-air bypass opening 61 upstream of the heater 30 of the air conditioning duct 11 like the above, air before heated by the heater 30 can be blown toward the vehicle compartment, particularly, a face of a passenger and thereabout through the cold bypass duct 62 and the face duct 51. Since air before heated by the heater 30 can be directly blown into the vehicle compartment, outside air before heated by the heater 30 can be blown inside the vehicle compartment. Therefore, when a temperature of outside air is low, cold air can be blown around the face of a passenger. Thereby, when the air conditioning apparatus for a vehicle 10 is used for heating, even if the upper half of a passenger's body is heated too much and he/she feels uncomfortable, the heat can be reduced by blowing outside cold air around his/her face through the cold-air bypass duct 62. As a result, uncomfortable feelings of a vehicle passenger can be reduced with a simple configuration.

The air conditioning apparatus for a vehicle 10 is often used for heating in winter where outside air temperature is low or-the like. However, even if outside air temperature is low, when solar rays are directly irradiated into the vehicle compartment of the vehicle 1 through the front glass 76 or the like, a temperature of a passenger in the vehicle compartment who is irradiated with the direct solar rays rises at only his/her body portion irradiated with the solar rays. That is, since a passenger easily receives direct solar rays on his/her upper half of body externally, even when an outside temperature is low, the passenger may be heated too much to feel uncomfortable due to solar rays irradiated on his/her upper half of body. In such a case, cold air blown around the face of a passenger through the cold-air bypass duct 62 can be adjusted by detecting an amount of solar radiation irradiated into the vehicle compartment by the solar radiation amount sensor 71 to open or close the cold-air bypass damper 63 according to the amount of solar radiation detected. Thereby, since cold air blown toward the face of a passenger can be adjusted according to the amount of solar radiation irradiated into the vehicle compartment, uncomfortable feelings due to direct solar rays to a passenger can be reduced. Accordingly, uncomfortable feelings of a passenger in a vehicle can be reduced more reliably with a simple configuration of the air conditioning apparatus for a vehicle.

As described above, when outside air is blown around the face of a passenger in order to reduce the heat of an upper half of body of the passenger, the upper half of body of the passenger is made hotter by blowing the outside air to the passenger in a state that the temperature of the outside air is high, which may result in increase in uncomfortable feelings of the passenger. On the other hand, a passenger is made to feel very cold by blowing outside air toward the passenger in a state that the compartment temperature is low, which may also result in uncomfortable feelings of the passenger. For suppressing uncomfortable feelings to a passenger from increasing, the air conditioning apparatus for a vehicle 10 employs such a configuration that an outside temperature and a temperature in the vehicle compartment are detected by the outside temperature sensor 72 and the compartment temperature sensor 73 provided in the vehicle, and when the outside temperature is high or when the compartment temperature is low, outside air is prevented from being blown toward the passenger by closing the cold-air bypass damper 63. Thereby, a temperature of air blown toward a passenger or the like can be changed over a long time running of the vehicle according to change in temperatures outside the vehicle 1 and in the vehicle compartment such that when the compartment temperature is lowered due to a long time opening of the cold-air bypass duct 62, the cold-air bypass damper 63 is closed, or when a-low outside air temperature rises according to a time elapsing, the cold-air bypass damper 63 is closed. Accordingly, even when the vehicle 1 travels for a long time, a temperature and an amount of air blown toward a passenger can be always adjusted automatically so that uncomfortable feelings of the passenger can be suppressed over a long time. Therefore, uncomfortable feelings of a passenger in a vehicle can be reduced more reliably with a simple configuration of the air conditioning apparatus for a vehicle.

The air adjusting apparatus for a vehicle 10 is often used for cooling when outside temperature is high, such as in summer. However, since cold air tends to flow downward, feet of a passenger become too cold when cooling is applied for a long time, which may result in uncomfortable feelings of the passenger. At that time, air just behind the heater 30, namely air that has passed through the heater 30 to be heated before being mixed with air cooled by the evaporator 18 can be blown toward the feet of the passenger through the hot-air bypass duct 66 and the foot duct 52 by actuating the heater 30 and opening the hot-air bypass damper 67. Accordingly, uncomfortable feelings of a passenger in a vehicle can be reduced even during use of cooling with a simple configuration of the air conditioning apparatus for a vehicle.

Since the cold-air bypass damper 63 and the hot-air bypass damper 67 can be opened/closed independently of opening/closing of the duct dampers 55, cold air from the cold-air bypass duct 62 or hot air from the hot-air bypass duct 66 can be blown toward a passenger regardless of opened/closed state of the duct dampers 55. For example, such a case occurs-that the air conditioning apparatus for a vehicle 10 is used for heating and hot air is blown to only feet of a passenger through the foot duct 52. In this case, a connection portion from the air conditioning duct 11 to the face duct 51 is closed by the duct damper 55. When direct solar rays are irradiated on a passenger in the vehicle 1 in this closed state, the upper half of the passenger's body may be heated to feel uncomfortable. Even in such a case, cold air from the cold-air bypass duct 62 can be blown around the face of a passenger via the face duct 51 by opening the cold-air bypass damper 63 independently regardless of opening/closing of the duct damper 55. In such a case, since the duct damper 55 positioned at-the connection portion of the face duct 51 and the air conditioning duct 11 is closed, cold air from the cold-air bypass duct 63 is directed toward the blow-off port without flowing toward the air flow passage 12. Similarly, hot air from the hot-air bypass duct 66 can be always blown out through the foot duct 52 by opening the hot-air bypass damper 67 regardless of opening/closing of the duct damper 55 provided at the connection portion of the foot duct 52 and the air conditioning duct 11. Accordingly, since cold air from the cold-air bypass duct 62 or hot air from the hot-air bypass duct 66 can be blown according to a condition of a passenger in a vehicle regardless of opening/closing the duct dampers 55, uncomfortable feelings of the passenger in the vehicle can be reduced more securely.

By opening/closing the cold-air bypass damper 63 or the hot-air bypass damper 67 independently of opening/closing of the duct damper 55, cold air from the cold-air bypass duct 62 or a hot air from the hot-air bypass duct 66 can be blown out via the duct 50 according to a passenger's liking in the vehicle without employing a configuration where temperature setting can be made for each blow-off port in the air conditioning apparatus for a vehicle 10. Therefore, uncomfortable feelings of a passenger in a vehicle can be reduced more securely with a simple configuration.

Since the cold-air bypass duct 62 is formed along the outer wall 17 of the air conditioning duct 11, the whole size or shape of the air conditioning apparatus for a vehicle 10 including the cold-air bypass duct 62 can be made compact. Thereby, a work for mounting the air conditioning apparatus for a vehicle 10 to the vehicle 1 can be made easy. As a result, increase in manufacturing cost due to mounting the cold-air bypass duct 62 can be suppressed. Because of the compact size or shape, the cold-air bypass duct 62 can be equipped even in a vehicle 1 with a small mounting space about the air conditioning apparatus for a vehicle 10. Accordingly, the cold-air bypass duct 62 can be mounted to many kinds or types of vehicles, so that uncomfortable feelings of a passenger in a vehicle can be reduced in many vehicle kinds of vehicles.

By blowing cold air toward a passenger, especially, a driver, as described above, his/her sleepiness during heating can be suppressed. Therefore, safety of a driver during driving a vehicle can be improved. In manufacturing an air conditioning apparatus for a vehicle 10 that allows reduction in uncomfortable feelings of a passenger, since uncomfortable feelings of a passenger can be reduced with such a simple configuration as connection of a portion of the air conditioning duct 11 and the face duct 51 conducted as described above, increase in manufacturing cost can be suppressed. As a result, since a manufacturing cost for an air conditioning apparatus for a vehicle 10 can be suppressed as a whole, the air conditioning apparatus for a vehicle 10 can be equipped even in a vehicle with a low price, which results in reduction in uncomfortable feelings of a passenger in many kinds of vehicles.

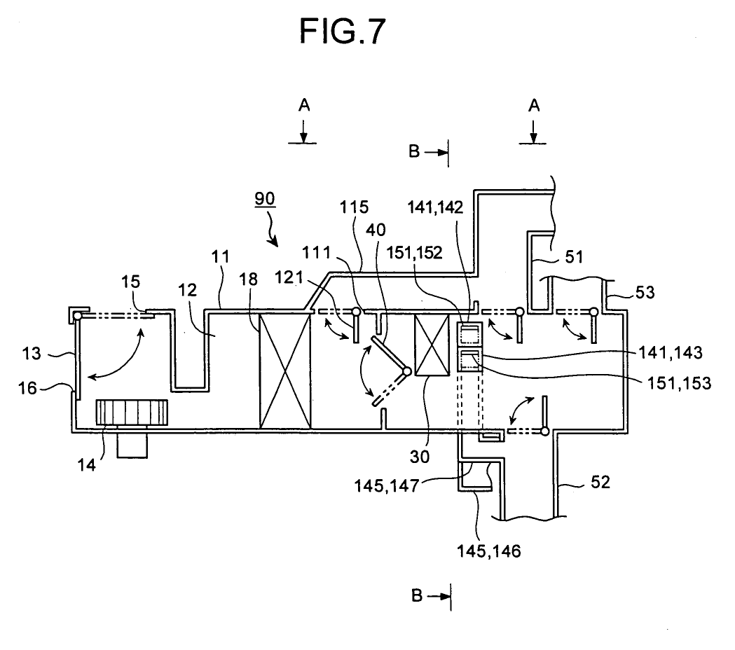

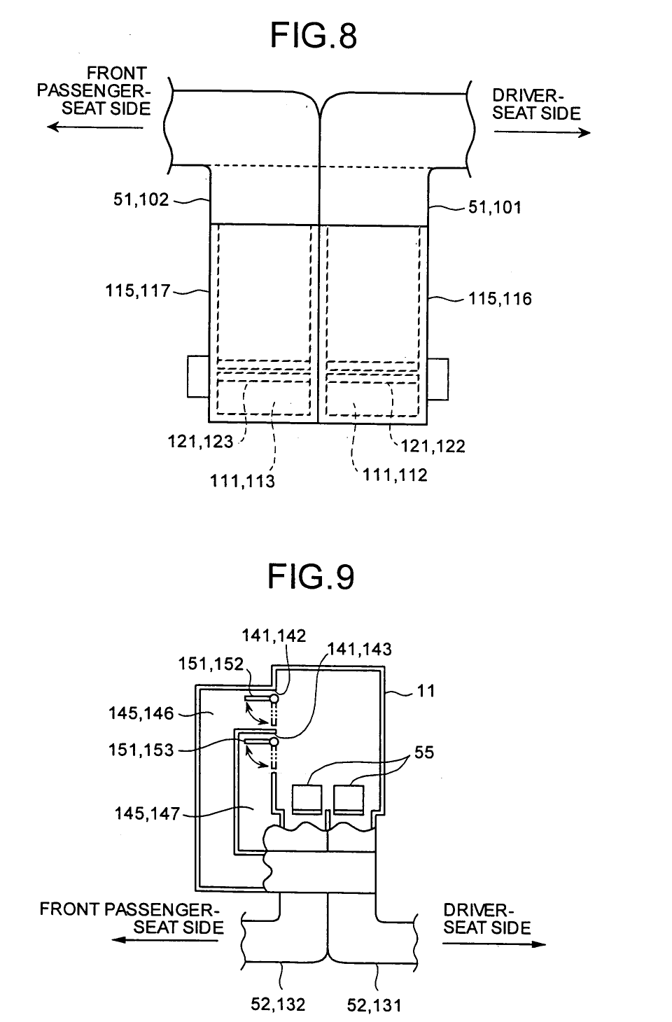

FIG. 7 is a view of an air conditioning apparatus for a vehicle according to a second embodiment of the present invention. FIG. 8 is a view of the air conditioning apparatus for a vehicle seen from arrow A-A in FIG. 7. FIG. 9 is a sectional view of the air conditioning apparatus for a vehicle taken along line B-B in FIG. 7. The air conditioning apparatus for a vehicle has a configuration approximately similar to that of the air conditioning apparatus for a vehicle according to the first embodiment, but a feature thereof is such that a control for blowing cold air or hot air to a driver seat side and a front passenger seat side independently of each other is provided. Since the other configuration of the second embodiment is the same as that of the first embodiment, explanations thereof are omitted, and like reference signs are designated to like parts or portions as those according to the first embodiment. The air conditioning apparatus for a vehicle 90 is provided with the face duct 51 like the cold-air bypass duct 62 in the air conditioning apparatus for a vehicle 10 according to the first embodiment. In the air conditioning apparatus for a vehicle 90 according to the second embodiment, however, face ducts 51 on a driver seat side and a front passenger seat independent of each other are connected with cold-air bypass ducts 115 independently. That is, a driver seat side face duct 101 is connected with a driver seat side cold-air bypass duct 116, the driver seat side cold-air bypass duct 115 is opened to the air conditioning duct 11 through a driver seat side cold-air bypass opening 112, and a driver seat side cold-air bypass damper 122 is provided at the driver seat side cold-air bypass opening 112. Similarly, a front passenger seat side face duct 102 is connected with a front passenger seat side cold-air bypass duct 117, the front passenger seat side cold-air bypass duct 117 is opened to the air conditioning duct 11 through a front passenger seat side cold-air bypass opening 113, and a front passenger seat side cold-air bypass damper 123 is provided at the front passenger seat side cold-air bypass opening 113. The driver seat side cold-air bypass damper 122 and the front passenger seat side cold-air bypass damper 123 can be opened/closed independently of each other.

Similarly, the air conditioning apparatus for a vehicle 90 is provided with the foot duct 52 like the hot-air bypass duct 66 of the air conditioning apparatus for a vehicle 10 according to the first embodiment. In the air conditioning apparatus for a vehicle 90 according to the second embodiment, however, foot ducts 52 on the driver seat side and the front passenger seat side independent of each other are connected with hot-air bypass ducts 145 independently. That is, a driver seat side foot duct 131 is connected with a driver seat side hot-air bypass duct 146, the driver seat side hot-air bypass duct 146 is opened to the air conditioning duct 11 through a driver seat side hot-air bypass opening 142, and a driver seat side hot-air bypass damper 152 is provided at the driver seat side hot-air bypass opening 142. Similarly, a front passenger seat side foot duct 132 is connected with a front passenger seat side hot-air bypass duct 147, the front passenger seat side hot-air bypass duct 147 is opened to the air conditioning duct 11 through a front passenger seat side hot-air bypass opening 143, and a front passenger seat side hot-air bypass damper 153 is provided at the a front passenger seat side hot-air bypass opening 143. The driver seat side hot-air bypass damper 152 and the front passenger seat side hot-air bypass damper 153 can be opened/closed independently of each other.

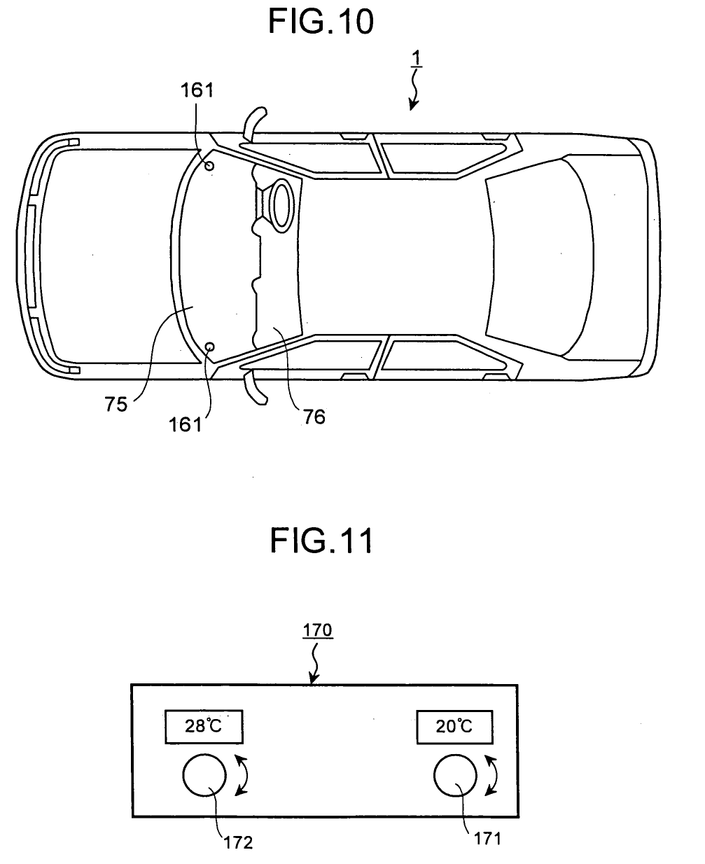

FIG. 10 is a plan view of a vehicle equipped with the air conditioning apparatus for a vehicle shown in FIG. 7. FIG. 11 is a view of an operation panel of the air conditioning apparatus for a vehicle according to the second embodiment. In the vehicle applied with the second embodiment, polarized solar radiation sensors 161 are provided on a dashboard 75 near the front glass 76. The polarized solar radiation sensors 161 are disposed on both the driver seat side and the front passenger seat side on the dashboard 75. The polarized solar radiation sensors 161 are electrically connected to the control unit 80 like the solar radiation amount sensor 71 or the like. The operation panel 170 of the air conditioning apparatus for a vehicle 90 according to the second embodiment is configured such that temperature setting can be conducted to the driver seat side and the front passenger seat side independently of each other, and temperature setting can be made by operating a driver seat side temperature setting dial 171 and a front passenger seat side temperature setting dial 172 independently of each other.

The air conditioning apparatus for a vehicle 90 according to the second embodiment is configured in the above manner, and an operation thereof will be explained below. The driver seat side face duct 101 is connected with the driver seat side cold-air bypass duct 116, and the driver seat side cold-air bypass duct 116 is provided with the driver seat side cold-air bypass damper 122. Further, the front passenger seat side face duct 102 is connected with the front passenger seat side cold-air bypass duct 117, and the front passenger seat side cold-air bypass duct 117 is provided with the front passenger seat side cold bypass damper 123. Therefore, air fed from the driver seat side cold-air bypass duct 116 or the front passenger seat side cold-air bypass duct 117 to the driver seat side face duct 101 or the front passenger seat side face duct 102 is independently adjusted by the driver seat side cold-air bypass damper 122 or the front passenger seat side bypass damper 123 independent of each other. Similarly, air fed from the driver seat side hot-air bypass duct 146 or the front passenger seat side hot-air bypass duct 147 to the driver seat side foot duct 131 or the front passenger seat side foot duct 132 is independently adjusted by the driver seat side hot-air bypass damper 152 or the front passenger seat side hot-air bypass damper 153 independent of each other.

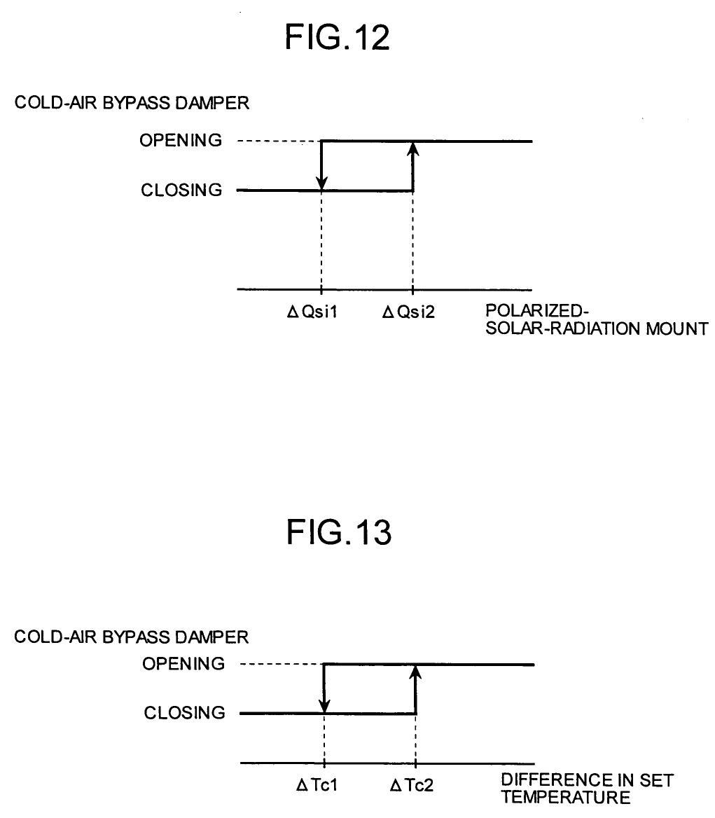

FIG. 12 is a diagram of opening and closing of a cold-air bypass damper corresponding to polarized solar radiation amount. An amount of solar radiation on the driver seat side and an amount of solar radiation on the passenger seat side are detected by the polarized solar radiation sensors 161. The control unit 80 connected with the polarized solar radiation sensors 161 determines a difference between the amount of solar radiation on the driver seat side and the amount of solar radiation on the front passenger seat side detected by the polarized solar radiation sensors 161 to control the cold-air bypass damper 121 based upon the difference. For example, when the amount of solar radiation on the driver seat side is more than that on the front passenger seat side during heating in the vehicle, predetermined values of values obtained by subtracting the amount of solar radiation on the front passenger seat side from the amount of solar radiation on the driver seat side are set to ΔQsi1 and ΔQsi2 (ΔQsi1<ΔQsi2). Assume changes of the cold-air bypass duct 115 due to changes of these values are seen from the driver seat side, while the driver seat side cold-air bypass damper 122 is in a closed state, when a difference between the values detected by the polarized solar radiation sensors becomes ΔQsi2 or more, (that is, when a difference between the amount of solar radiation on the driver seat side and the amount of solar radiation on the front passenger seat side becomes large) the driver seat side cold-air bypass damper 122 is opened. Furthermore, while the driver seat side cold-air bypass damper 122 is in an opened state, when a difference between the values detected by the polarized solar radiation sensors 161 becomes ΔQsi1 or less, that is, when a difference between the amount of solar radiation on the driver seat side and the amount of solar radiation on the front passenger seat side becomes small, the driver seat side cold-air bypass damper 122 is closed.

FIG. 13 is a diagram of opening and closing of a cold-air bypass damper corresponding to a difference in set temperature. When a temperature for a vehicle compartment is set through the operation panel 170 such that a difference between set temperatures to the driver seat side and the front passenger seat side is large, that is, when a difference between set temperatures to the driver seat side and the front passenger seat side becomes large due to temperature setting to the driver seat side conducted by a driver seat side temperature setting dial 171 and temperature setting to the front passenger seat side conducted by a front passenger seat side temperature setting dial 172 independent of each other, the cold-air bypass damper 121 and the hot-air bypass damper 151 are controlled according to the difference. For example, when the set temperature on the driver seat side is low during heating, predetermined values of values obtained by subtracting the set temperature on the driver seat side from the set temperature on the front passenger seat side are set to ΔTc1 and ΔTc2 (ΔTc1<ΔTc2). Assume the state of the cold-air bypass duct 115 due to the degree of the difference is seen from the driver seat side, while the driver seat side cold-air bypass damper 122 is in a closed state, when a difference between the set temperature on the driver seat side and the set temperature on the front passenger seat side is made to ΔTc2 or more, (that is, when the difference between the set temperature on the driver seat side and the set temperature on the front passenger seat side becomes large) the driver seat side cold-air bypass damper 122 is opened. Furthermore, while the driver seat side cold-air bypass damper 122 is in an opened state, when the difference between the set temperature on the driver seat side and the set temperature on the front passenger seat side is made to ΔTc1 or less, that is, when a difference between the set temperature on the driver seat side and the set temperature on the front passenger seat side is made small, the driver seat side cold-air bypass damper 122 is closed.

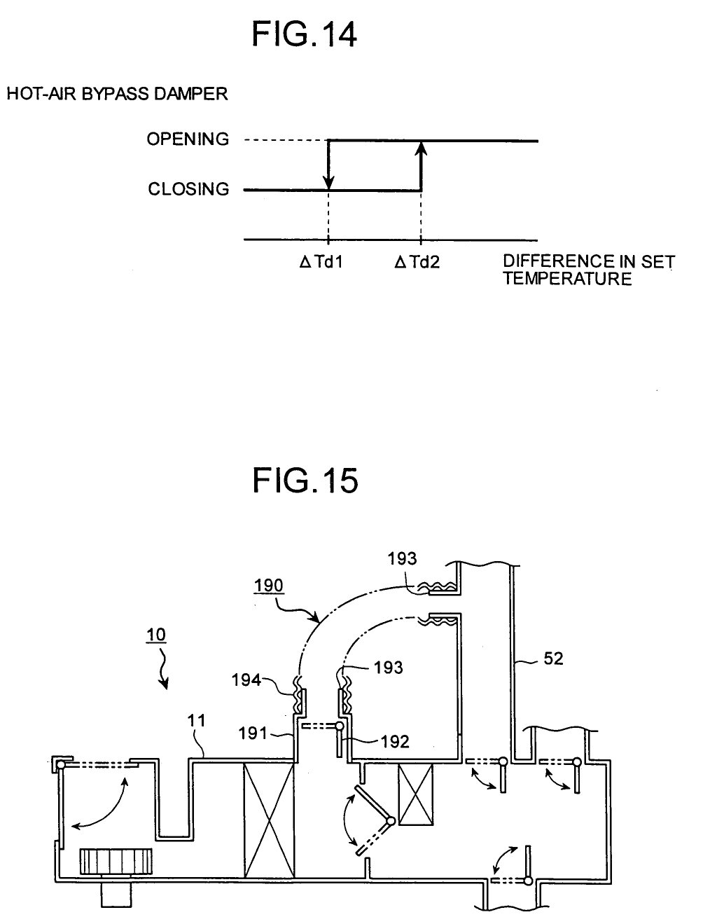

FIG. 14 is a diagram of opening and closing of a hot-air bypass damper to a difference between set temperatures. For example, when a set temperature on the driver seat side is high during cooling, predetermined values of values obtained by subtracting the set temperature on the front passenger seat side from the set temperature on the driver seat side are set to ΔTd1 and ΔTd2 (ΔTd1<ΔTd2). Assume the state of the hot-air bypass duct 145 due to the degree of the difference is seen from the driver seat side, while the driver seat side hot-air bypass damper 152 is in a closed state, when a difference between the set temperature on the driver seat side and the set temperature on the front passenger seat side is made to ΔTd2 or more, (that is, when the difference between the set temperature on the driver seat side and the set temperature on the front passenger seat side becomes large) the driver seat side hot-air bypass damper 152 is opened. Further, while the driver seat side hot-air bypass damper 152 is in an opened state, when the difference between the set temperature on the driver seat side and the set temperature on the front passenger seat side is made to ΔTd1 or less, that is, when a difference between the set temperature on the driver seat side and the set temperature on the front passenger seat side is made small, the driver seat side hot-air bypass damper 152 is closed.

The air conditioning apparatus for a vehicle 90 described above can control an amount of cold air blown toward a passenger through the cold-air bypass damper 121 according to the amounts of solar radiation irradiated to the driver seat and the front passenger seat. For example, when the amount of solar radiation to the driver seat is more than that to the front passenger seat, since the driver seat side cold-air bypass damper 122 is opened, cold air is blown from the driver seat side face duct 101 around the face of the driver. Such a fact that the amount of solar radiation to the driver seat is more than that to the front passenger seat means that the amount of solar radiation to an upper half of a body of the driver, such as a face, is too much. Therefore, the upper half of the driver's body may be heated and he/she feels uncomfortable. Since cold air is blown around the face of the driver, as described above, the heat on the driver can be reduced, so that his/her uncomfortable feelings can be reduced. When the difference in amount of solar radiation between the driver seat and the front passenger seat becomes small, the driver seat side cold-air bypass damper 122 is closed. When the difference in amount of solar radiation between the driver seat and the front passenger seat is small, adjustment can be made by setting a temperature in the room or compartment. Even if the difference in amount of solar radiation between the driver seat and the front passenger seat is reduced by closing the cold-air bypass damper 122 in this manner, cold air is always prevented from being blown from one of the face ducts 51. Accordingly, a difference in uncomfortable feelings due to a seating position of a passenger can be reduced, so that the uncomfortable feelings of the passenger can be reduced more securely.

When temperature setting is made for the room or compartment, temperature settings to the driver seat side and the front passenger seat side can be made by the operation panel 170 independently of each other, such a case occurs that both the temperature setting are considerably different from each other due to a condition(s) of a passenger(s), his/her (their) effective temperature(s) or the like. Even in such a case, air with a temperature corresponding to the difference in set temperature between the driver seat side and the front passenger seat side can be blown to the room or compartment through the cold-air bypass duct 115 and the hot-air bypass duct 145. For example, when a set temperature on the front passenger seat side is low and a set temperature on the driver seat side is further remarkably lower than that on the front passenger seat side, the driver seat side cold-air bypass damper 122 is opened so that cold air is blown from the driver seat side face duct 101 around the face of the driver, as described above. Such a fact that both the set temperatures on the front passenger seat side and the driver seat side are low means a state that the air conditioning apparatus for a vehicle 90 is in use for cooling. Further, such a fact that the set temperature on the driver seat side is considerably lower than the set temperature on the front passenger seat side means he/she feels uncomfortable, because the passenger on the driver seat side feels hot in the compartment even during cooling,. In this case, the effective temperature of the driver is lowered by blowing cold air around the face of the driver, so that uncomfortable feelings of the driver can be reduced, as described above.

When the set temperature on the driver seat side is high and the set temperature on the front passenger seat side is further considerably higher than that on the driver seat side, the front passenger seat side hot-air bypass damper 153 is opened so that hot air is blown from the front passenger′ seat side foot duct 132 around the feet of a passenger on the front passenger′ seat side, as described above. Such a fact that the set temperatures on both the driver seat side and the front passenger seat side are high means a state that the air conditioning apparatus for a vehicle 90 is in use for heating. Further such a fact that the set temperature on the front passenger seat side is considerably higher than that on the driver seat side means he/she feels uncomfortable, because the passenger on the front passenger seat side feel cold in the room or compartment even during heating. In this case, the effective temperature of the passenger on the front passenger seat side is raised by blowing hot air around the feet of the passenger on the front passenger seat side, so that uncomfortable feelings of the passenger can be reduced, as described above. Accordingly, uncomfortable feelings of plural passengers due to differences in effective temperature among them or the like can be reduced so that uncomfortable feelings of the passengers can be reduced more securely. Since cold air or hot air blown to a passenger on each seating position can be controlled independently, so that uncomfortable feeling(s) of passenger(s) can be reduced more securely with a simple configuration.

Cold air from the cold-air bypass duct 115 or hot air from the hot-air bypass duct 145 can be accurately blown via the ducts 50 according to tastes of a passenger in the vehicle by opening/closing the cold-air bypass damper 121 or the hot-air bypass damper 151 independently of opening/closing the duct dampers 55 like the first embodiment without configuring the air conditioning apparatus for a vehicle 90 such that temperature setting can be made for each blow-off port. For example, while the air conditioning apparatus for a vehicle 90 is in use for heating and hot airs are being blown from only the driver seat side foot duct 131 and the front passenger seat side foot duct 132, such a case occurs that a passenger on the front passenger seat side feel comfortable but a passenger on the driver seat side feels uncomfortable due to heat. In such a case, by opening only the driver seat side cold-air bypass damper 122, cold air can be blown only around the face of the passenger on the driver seat side, so that uncomfortable feelings of the passenger can be reduced. As a result, uncomfortable feelings of the passenger in a vehicle can be reduced more securely with the simple configuration.

FIG. 15 is a modification of the first embodiment. Incidentally, the cold-air bypass duct 62 according to the first embodiment is formed along the air conditioning duct 11. In the modification, however, a cold-air bypass duct 190 can be fixed to the air conditioning duct 11, and a damper switching portion 191 equipped with a cold-air bypass damper 192 is newly provided. Further, such a configuration can be employed that nozzle connecting portions 193 are provided on the damper switching portion 191 and the face duct 52, and they are connected by a flexible nozzle 194 such as a member formed in a bellows shape so as to be flexible therebetween. Thereby, in any positional relationship between the air conditioning duct 11 and the face duct 52, the cold-air bypass duct 190 can be provided by only adding the damper switching portion 191 and the nozzle connecting portions 193 to connect them by the flexible nozzle 194. Therefore, when the cold-air bypass duct 190 is provided to an air conditioning apparatus for a vehicle, the air conditioning apparatus for a vehicle 10 can be equipped in many kinds of vehicles regardless of the vehicle kind thereof. By setting the cold-air bypass duct 190 as an optional member and adding the damper switching portion 191 and the nozzle connecting portions 193, as needed, various demands can be satisfied. As a result, the air conditioning apparatus for a vehicle 10 with a high utility can be manufactured.

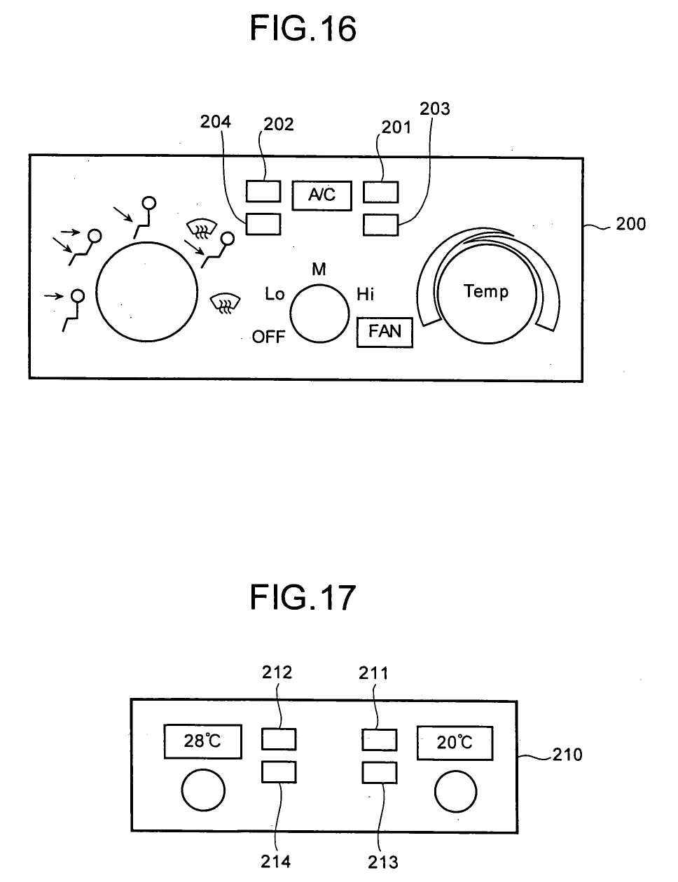

FIG. 16 is an example of an operation panel of an air conditioning apparatus for a vehicle according to the present invention. FIG. 17 is another example of an operation panel of an air conditioning apparatus for a vehicle according to the present invention. The case that the air conditioning apparatus for a vehicle 10, 90 is the so-called automatic air conditioners where adjustment to a set temperature is automatically made by the control unit 80 has been explained, but the air conditioning apparatus for a vehicle 10, 90 may be a manual type air conditioner where adjustment is made by respective switches provided on an operation panel 200. In this case, air flow to the cold-air bypass duct 62, 115 or the hot-air bypass duct 66, 145 is conducted by turning ON/OFF respective switches of a driver seat side cold-air bypass switch 201, a front passenger seat side cold-air bypass switch 202, a driver seat side hot-air bypass switch 203, and a front passenger seat side hot-air bypass switch 204 provided on the operation panel 200. Similarly, even in the automatic air conditioner, automatic control may be performed like the above when respective switches of a driver seat side cold-air bypass switch 211, a front passenger seat side cold-air bypass switch 212, a driver seat side hot-air bypass switch 213, and a front passenger seat side hot-air bypass switch 214 provided on an operation panel 210 are turned ON.

The air conditioning apparatus for a vehicle 10, 90 described above is provided with both the cold-air bypass duct 62, 115 and the hot-air bypass duct 66, 145, but only the cold-air bypass duct 62, 115 or the hot-air bypass duct 66, 145 may be provided in the present invention. Briefly, if such a configuration that air passing through the cold-air bypass duct 62, 115, or the hot-air bypass duct 66, 145 is blown to a passenger, as necessary, is employed, any specific configuration can be employed in the present invention. Each damper such as the cold-air bypass damper 63 can adopt not only the configuration shown in each figure but also any configuration such as a slide type-configuration, if the configuration allows opening/closing of an opening.

According to the first embodiment, the solar radiation amount sensor 71, the outside temperature sensor 72, and the compartment temperature sensor 73 are provided, and the polarized solar radiation sensors 161 are provided according to the second embodiment. However, any combination of these sensors may be used and each sensor may be used alone. A sensor to be used may be one other than the above-described sensors. Any kind of a sensor that can detect situation in a compartment of a vehicle or outside the vehicle and can sense an uncomfortable environment for a passenger by combination with the control unit 80 can be used in any combination. In the above embodiment, the cold-air bypass damper 63, 121 is opened/closed based upon the detection result of each sensor, but the hot-air bypass damper 67, 151 may be opened/closed based upon the detection result of each sensor. For example, while the air conditioning apparatus for a vehicle 10 is in use for cooling, when the amount of solar radiation detected by the solar radiation amount sensor 71 decreases, excessive cooling during cooling can be suppressed by opening the hot-air bypass damper 67. By opening/closing the hot-air bypass damper 63, 121 according to the detection result of each sensor in this manner, uncomfortable feelings of a passenger due to excessive cooling in the vehicle compartment can be suppressed.

The air conditioning apparatus for a vehicle and the method for controlling an air conditioning apparatus for a vehicle according to the present invention can reduce uncomfortable feelings of a vehicle passenger with a simple configuration or method.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An air conditioning apparatus for a vehicle, comprising:
a plurality of ducts that is connected to a plurality of blow-off ports provided in a compartment of the vehicle;
an air flow passage to which the ducts are connected, the air flow passage having a vehicle external opening that is a portion opened to outside of the vehicle;
a duct opening/closing unit that opens/closes the air flow passage and the ducts;
a heater provided between the vehicle external opening and a portion of the air flow passage connected with the ducts;
a cold-air bypass duct with one end opened to the ducts and other end opened between the vehicle external opening and the heater through a cold-air bypass opening; and
a cold-air bypass opening/closing unit that is provided at either of the cold-air bypass opening and the cold-air bypass duct, and opens/closes the either of the cold-air bypass opening and the cold-air bypass duct independently of opening/closing the duct opening/closing unit.

2. The air conditioning apparatus according to claim 1, wherein
a plurality of the cold-air bypass ducts is prepared,
the cold-air bypass ducts are opened to at least two ducts independently in such a manner that one cold-air bypass duct is opened to one duct,
the cold-air bypass opening is independently provided on each of the cold-air bypass ducts, and
the cold-air bypass opening/closing unit is independently provided on either of the cold-air bypass opening and the cold-air bypass duct.

3. The air conditioning apparatus for a vehicle according to claim 1, further comprising:
a solar-radiation-amount detecting unit that detects an amount of solar radiation irradiated on the vehicle; and
a control unit that is connected with the solar-radiation-amount detecting unit and the cold-air bypass opening/closing unit, and controls an opening degree of the cold-air bypass opening/closing unit based on the amount of solar radiation detected.

4. The air conditioning apparatus according to claim 3, further comprising:
an outside-temperature detecting unit that is connected to the control unit, and detects an outside temperature of a periphery of the vehicle; and
a compartment-temperature detecting unit that is connected to the control unit, and detects a compartment temperature inside the compartment of the vehicle, wherein
the control unit controls the opening degree of the cold-air bypass opening/closing unit based on the outside temperature and the compartment temperature detected.

5. The air conditioning apparatus according to claim 1, further comprising:
a hot-air bypass duct with one end opened to the ducts and other end opened between the portion of the air flow passage connected with the ducts through a hot-air bypass opening and the heater; and
a hot-air bypass opening/closing unit that is provided on either of the hot-air bypass opening and the hot-air bypass duct, and opens/closes the either of the hot-air bypass opening and the hot-air bypass duct independently of opening/closing of the duct opening/closing unit.

6. The air conditioning apparatus according to claim 5, wherein
a plurality of the hot-air bypass ducts is prepared,
the hot-air bypass ducts are opened to at least two ducts independently in such a manner that one cold-air bypass duct is opened to one duct,
the hot-air bypass opening is independently provided on each of the hot-air bypass ducts, and
the hot-air bypass opening/closing unit is independently provided on either of the cold-air bypass opening and the cold-air bypass duct.

7. The air conditioning apparatus for a vehicle according to claim 1, wherein either of the cold-air bypass duct and the hot-air bypass duct or both are formed integrally along an outside wall of the air flow passage.

8. A method for controlling an air conditioning apparatus for a vehicle, the air conditioning apparatus having a duct that feeds air into a compartment of the vehicle and a cold-air bypass duct opened to the duct to feed cold air into the compartment in response to feeding the air from the duct, the comprising:
detecting an amount of solar radiation irradiated on the vehicle; and
adjusting an amount of the cold air from the cold-air bypass duct based on the amount of the solar radiation in such a manner that the amount of the cold air increases as the amount of solar radiation detected increases, and the amount of the cold air decreases as the amount of solar radiation detected decreases.

9. The method according to claim 8, further comprising:
detecting an outside temperature of the vehicle and a compartment temperature in the vehicle; and
feeding, when the outside temperature is equal to or lower than a first predetermined temperature and the compartment temperature is equal to or higher than a second predetermined temperature, the cold air into the compartment.
